(19) United States
(12) Patent Application Publication
(10) Pub. No.: US 2016/0191461 A1
(43) Pub. Date: Jun. 30, 2016

(54) TURN Relay Service Reuse For NAT Traversal During Media Session Resumption

(71) Applicant: Futurewei Technologies, Inc., Plano, TX (US)

(72) Inventor: Xiaobo Wang, San Jose, CA (US)

(21) Appl. No.: 14/587,985

(22) Filed: Dec. 31, 2014

(51) Int. Cl. H04L 29/12; H04L 29/06

(52) U.S. Cl. CPC H04L 61/2589; H04L 65/1069; H04L 61/20; H04L 65/608

(57) ABSTRACT

A call media session restoration method comprising detecting a network reconnection triggering event that disconnects a media session for a client and a relay connection on a network device for the media session, sending a relay address allocation request to the network device, wherein the relay address allocation request comprises a session update attribute that identifies the relay connection, receiving a user authentication request message from the network device, authenticating the relay address allocation request with the network device, wherein the relay address allocation request is authenticated in accordance with the user authentication request message, and wherein authenticating the relay address allocation request comprises resending the session update attribute, and performing a connectivity check between the client and a peer via the relay connection, wherein performing the connectivity check restores the media session and the relay connection and reuses the relay address for the relay connection.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A Network Address Translator (NAT) device modifies Internet Protocol (IP) headers as packets transits across the NAT device which can block Voice over IP (VoIP) calls. Some firewalls are configured to block User Datagram Protocol (UDP) and may only allow Hypertext Transfer Protocol (HTTP) or HTTP Secure (HTTPS) to pass, for example, for security reasons. As such, NAT devices and firewalls configured to block UDP can block media communications, such as, VoIP. A web browser (commonly referred to as a browser) is a software application for retrieving, presenting, and traversing information resources on the World Wide Web. Some web browsers utilize a technology referred to as Web Real-Time Communications (WebRTC). WebRTC is a technology drafted by the Worldwide Web Consortium (W3C) that enables browser-based applications (e.g., a JavaScript client in a browser) to support audio or video-calling, video chat, peer-to-peer (P2P) file sharing, and the like, without requiring a plugin in the browser. WebRTC uses Traversal Using Relays around NATs (TURN) and Session Traversal Utilities for NATs (STUN) protocols for NAT/Firewall (FW) traversal. WebRTC clients reserve relay resources (e.g., relay addresses and bandwidth) on a TURN server before or during a call. If the client detects that a NAT or a firewall device blocks direct media communications between the client and a peer, then the client may use a TURN relays server to traverse the NAT/FW devices.

When a user is visiting a web site and starts using a web session, the user device may briefly lose a connection due to a network reconnection triggering event. A network reconnection trigger event may include, but is not limited to, a user refreshing a page, a user leaving a page (e.g., clicks back or forth button), a device moving out of and back into a hot spot, and a device turning off and back on. At a later time the user is able to reestablish the network connection and to restore the web session. During web session restoration, the browser will recreate all network connections and will resume web session (e.g., using session cookies). Web session restoration recovers a web session, but does not recover the media session. For example, a user will have to call another user again if web session restoration occurs during a call (e.g., a video conference or a Voice over Internet Protocol (VoIP) call). To maintain a consistent user experience, a web session should be recovered within an allotted time window (e.g., less than a minute). Otherwise, a user will lose active media sessions and will have to call peers again to continue a web session when the web session is not recovered within the time window. It is desirable to reuse TURN relay resources during media session restorations to simplify the media restoration process and to reduce restoration time.

### SUMMARY

In one embodiment, the disclosure includes a call media session restoration method comprising detecting a network reconnection triggering event that disconnects a media session for a client and a relay connection on a network device for the media session, sending a relay address allocation request to the network device, wherein the relay address allocation request comprises a session update attribute that identifies a relay address for the relay connection, receiving a user authentication request message from the network device in response to sending the relay address allocation request, authenticating the relay address allocation request with the network device, wherein the relay address allocation request is authenticated in accordance with the user authentication request message, and wherein authenticating the relay address allocation request comprises resending the session update attribute, and performing a connectivity check between the client and a peer via the relay connection, wherein performing the connectivity check restores the media session and the relay connection, and wherein restoring the relay connection reuses the relay address for the relay connection.

In another embodiment, the disclosure includes an apparatus, comprising a receiver configured to receive signaling commands and data traffic, and a processor coupled to a memory and the receiver, wherein the memory comprises computer executable instructions stored in a non-transitory computer readable medium such that when executed by the processor causes the processor to detect a network reconnection triggering event that disconnects a media session for a client and a relay connection on a network device for the media session, send a relay address allocation request to the network device, wherein the relay address allocation request comprises a session update attribute that identifies a relay address for the relay connection, receive a user authentication request message from the network device in response to sending the relay address allocation request, authenticate the relay address allocation request with the network device, wherein the relay address allocation request is authenticated in accordance with the user authentication request message, and wherein authenticating the relay address allocation request comprises resending the session update attribute, and perform a connectivity check between the client and a media gateway via the relay connection, wherein performing the connectivity check restores the media session and the relay connection, and wherein restoring the relay connection reuses the relay address for the relay connection.

In yet another embodiment, the disclosure includes an apparatus, comprising a receiver configured to receive signaling commands and data traffic, and a processor coupled to a memory and the receiver, wherein the memory comprises computer executable instructions stored in a non-transitory computer readable medium such that when executed by the processor causes the processor to receive a relay address allocation request from a client following a network reconnection triggering event, wherein the relay address allocation request comprises a session update attribute that identifies a relay connection address for a relay connection for a media session, and wherein the network reconnection triggering event disconnects the media session and the relay connection on a network device for the media session, send a user authentication request message to the client to authenticate the relay address allocation request with the client, determine whether the relay connection address is still active, send a relay address allocation request success message to the client, and relay a connectivity check between the client and a peer using the relay connection when the relay address allocation request is authenticated and the relay connection address is still active, wherein relaying the connectivity check restores the media session and the relay connection, and wherein restoring the relay connection reuses the relay connection address.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a WebRTC system.

FIG. 2 is a schematic diagram of an embodiment of a network element used to transport and process data traffic through a WebRTC system.

FIG. 3 is a protocol diagram of an embodiment of a relay service establishing method.

FIG. 4 is a flowchart of an embodiment of a relay service establishing method for a network device.

FIG. 5 is a flowchart of another embodiment of a relay service establishing method for a network device.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are various embodiments for establishing a relay service (e.g., a relay connection) for a media session of a web session and restoring the relay services for a media session after a network reconnection triggering event. A relay service provides access for communicating data traffic and/or media traffic among network devices. For example, a relay service can provide traversal access through a symmetric NAT device. Relay services may include, but are not limited to, a relay connection or a relay address (e.g., a TURN relay connection) and the reserved bandwidth for the relay address on a relay server. The terms “relay connection” and “relay address” may be used interchangeably. In an embodiment, a network device is configured to establish a relay service for a media session (e.g., a VoIP voice media session or a WebRTC voice/video media session), to detect a network reconnection triggering event (e.g., a session change), and to reestablish relay service for the media session in response to detecting the network reconnection triggering event. In various embodiments, relay services (e.g., relay addresses, bandwidth, peer permissions, and channel information for relay connections) are reused. A call restoration protocol that utilizes a STUN/TURN protocol to perform NAT traversal can be employed to restore a media session by reusing relay services. Messages for relay service allocation requests, peer permission, and/or channel binding may be reduced which may also reduce call setup time.

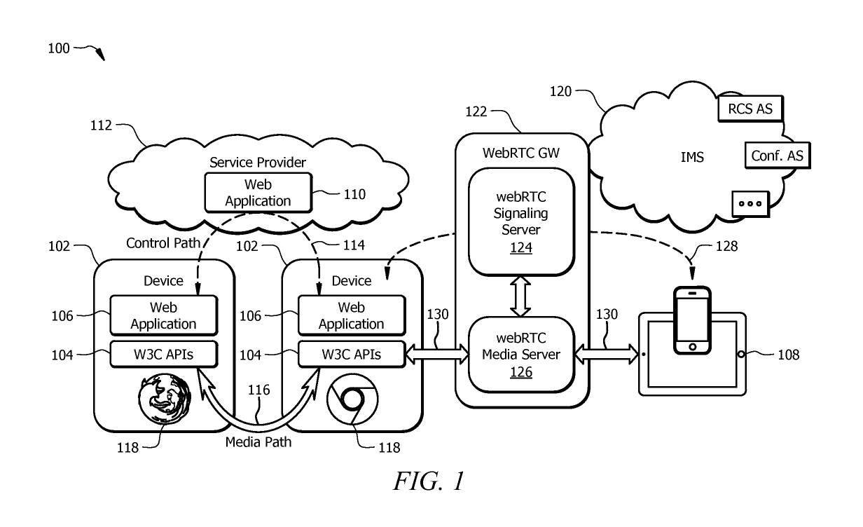

FIG. 1 is a schematic diagram of a WebRTC system 100. WebRTC is described in more detail in the W3C Working Draft 10 document WebRTC 1.0: Real-time Communication Between Browsers published in September 2013, and in the W3C Editor's Draft 01 document WebRTC 1.0: Real-time Communication Between Browsers published in July 2014, both of which are incorporated herein by reference as if reproduced in their entirety. As shown in FIG. 1, the WebRTC system 100 includes one or more computing devices, which for convenience will be referred to herein as clients 102. In some embodiments, one or both of the clients 102 is a personal computer (PC), tablet computer, or mobile phone. In some embodiments, each client 102 includes one or more W3C Application Program Interfaces (APIs) 104 used to handle a web application 106. For example, web application 106 can be a web page configured to execute JavaScript. In another example, the web application 106 is a web application with video calling capabilities (e.g., a collaboration application) or to otherwise facilitate communication between the clients 102 or between one of the clients 102 and a target 108. The web application 106 of each client 102 is configured to communicate with the corresponding web application 110 of a service provider 112 through a control path 114. As such, the service provider 112 provides the appropriate signaling to facilitate, for example, a video call between the clients 102. The media for the video call is exchanged between the clients 102 through a media path 116. Each client 102 also includes a browser 118 (e.g., Mozilla Firefox®, Google Chrome®, Microsoft Internet Explorer®, or Apple Safari®). The browser permits a user of the client 102 to interact with the web application 106. In some cases, the browser 118 of the client 102 is configured to support WebRTC communications. When the browser 118 of the client 102 supports WebRTC, the clients 102 are able to engage in multi-media communications (e.g., browser-to-browser communications, browser-to-phone communications, and browser-to-voice over internet protocol (VoIP) communications) without the need for a plugin. As an example, when one client 102 wants to initiate a video call with the other client 102, the web application 106 of the client 102 initiating the video call contacts the web application 110 of the service provider 112 to request that the service provider 112 provide the signaling to facilitate the call. The web application 110 of the service provider 112 provides the requested signaling using the control path 114 and the clients 102 exchange media over the media path 116. When the user of one client 102 wants to end the video call, the web application 106 of that client 102 advises the web application 110 of the service provider 112 of the desire to end the call, the signaling used to facilitate the video call ceases, and the exchange of media between the clients 102 over the media path 116 ends.

In some circumstances, the target 108 is a mobile device (e.g., a smart phone, tablet, etc.) that communicates though an IP multimedia system (IMS) 120, a circuit switch (CS), or a public switched telephone network (PSTN) and does not support WebRTC. Because the target 108 does not support WebRTC, the clients 102 are unable to engage in browser-to-browser communications with the target 108. For example, the codec used for encoding and decoding the digital data stream or signal of the target 108 is different than the codec used for encoding and decoding the digital data stream or signal of the client 102. In order for the target 108 to communicate with one of the clients 102, a WebRTC gateway 122 is utilized. The WebRTC gateway 122 extends, for example, the IMS subscribers (e.g., the target 108) to the web domain of the service provider 112 and enables those subscribers to enjoy existing services, such as, Rich Communication Services (RCS), conference as a service, and so on. The WebRTC gateway 122 is configured to convert the digital data stream or signals from the clients 102 into a format that the target 108 is capable of utilizing, and vice versa. The WebRTC gateway 122 is also configured to provide the signaling needed to facilitate communications between the clients 102 and the target 108. In some embodiments, the WebRTC gateway 122 comprises a signaling server 124 and a media server 126. As used herein, the signaling server 124 may be referred to as a signaling gateway and the media server 126 may be referred to as a media gateway. As shown, the signaling server 124 and the media server 126 are operably coupled to each other. While the signaling server 124 and the media server 126 are shown proximate one another in FIG. 1, the signaling server 124 and the media server 126 may be remotely located from each other in some embodiments. The signaling server 124 is configured to handle a transport protocol (e.g., HTTPS) and a signaling protocol (e.g., session initiation protocol (SIP)). For example, signaling server 124 may be configured to implement SIP over WebSocket or JavaScript Object Notation (JSON) over WebSocket. Additional information for WebSocket may be similar to as described in Internet Engineering Task Force (IETF) Request For Comments (RFC) 6455 entitled, “The WebSocket Protocol,” by Fette et al., published December 2011, which is hereby incorporated by reference as if reproduced in its entirety. Therefore, the signaling server 124 is able to provide the signaling for communication between the clients 102 and the target 108 through a control path 128. For example, the signaling server 124 uses the control path 128 to send a phone call notification to the target 108 when one of the clients 102 is attempting to place a video call to the target 108. As shown in FIG. 1, the media server 126 provides media to the clients 102 and to the target 108 through a media path 130 extending between the WebRTC gateway 122 and the clients 102 and between the WebRTC gateway 122 and the target 108. Thus, media (e.g., data from a video call) from one of the clients 102 is delivered to the media server 126 in the WebRTC gateway 122 over the media path 130, converted into a format consistent with the target 108 by the media server 126, and then delivered by the media server 126 to the target 108 over the media path 130. Likewise, media from the target 108 is delivered to the media server 126 in the WebRTC gateway 122 over the media path 130, converted into a format consistent with the client 102 by the media server 126, and then delivered by the media server 126 to the client 102 over the media path 130. In this fashion, the clients 102 and the target 108 are able to participate in communications, such as, video calls, video chats, peer-to-peer file sharing, and so on. Media server 126 may comprise an integrated TURN server to support NAT/FW traversal that need relay services. For example, if a client 102 is behind a symmetric NAT device or a restrictive firewall that blocks UDP, then the client 102 may not be able to establish a direct media connection to a peer. Client 102 will use a relay service from media server 126 to traverse the NAT/FW and to communicate with the peer. In another embodiment, a TURN server may not be incorporated with media server 126. A TURN server may be an independent device or incorporated with any other suitable network device as would be appreciated by one of ordinary skill in the art upon viewing this disclosure.

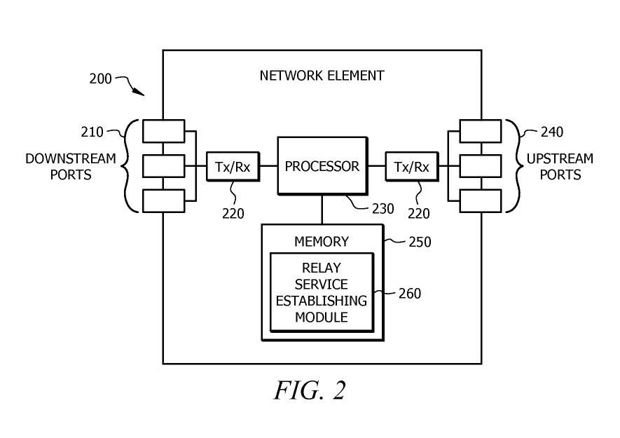

FIG. 2 is a schematic diagram of an embodiment of a network element 200 used to transport and process data traffic or information through a WebRTC system 100 shown in FIG. 1. For example, network element 200 is implemented in and/or integrated within a client 102 or a target 108 described in FIG. 1. At least some of the features/methods described in the disclosure are implemented in the network element 200. For instance, the features/methods of the disclosure may be implemented in hardware, firmware, and/or software installed to run on the hardware. The network element 200 may be any device (e.g., a modem, a switch, router, bridge, server, client, etc.) that transports data through a network, system, and/or domain. Moreover, the terms network “element,” “node,” “component,” “module,” and/or similar terms may be interchangeably used to generally describe a network device and do not have a particular or special meaning unless otherwise stated and/or claimed within the disclosure. In one embodiment, the network element 200 is an apparatus configured to establish a web session and a media session (e.g., a WebRTC call), to establish a relay service (e.g., a relay connection) for a media session, to communicate data traffic, to detect network reconnection triggering event, and to restore the relay service by reusing relay services following a network reconnection triggering event.

The network element 200 comprises one or more downstream ports 210 coupled to a transceiver (Tx/Rx) 220, which may be transmitters, receivers, or combinations thereof. The Tx/Rx 220 transmit and/or receive frames from other network nodes via the downstream ports 210. Similarly, the network element 200 comprises another Tx/Rx 220 coupled to a plurality of upstream ports 240, wherein the Tx/Rx 220 transmit and/or receive frames from other nodes via the upstream ports 240. The downstream ports 210 and/or the upstream ports 240 may include electrical and/or optical transmitting and/or receiving components.

A processor 230 may be coupled to the Tx/Rx 220 and may be configured to process the frames and/or determine which nodes to send (e.g., transmit) the packets. In an embodiment, the processor 230 may comprise one or more multi-core processors and/or memory modules 250, which may function as data stores, buffers, etc. The processor 230 may be implemented as a general processor or may be part of one or more application specific integrated circuits (ASICs), field-programmable gate arrays (FPGAs), and/or digital signal processors (DSPs). Although illustrated as a single processor, the processor 230 is not so limited and may comprise multiple processors. The processor 230 may be configured to establish a web session and a media session (e.g., a WebRTC call), to establish a relay service for the media session, to detect a network reconnection triggering event, and to restore the relay service by reusing relay services following a network reconnection triggering event.

FIG. 2 illustrates that a memory module 250 is coupled to the processor 230 and may be a non-transitory medium configured to store various types of data. Memory module 250 may comprise memory devices including secondary storage, read-only memory (ROM), and random-access memory (RAM). The secondary storage is typically comprised of one or more disk drives, optical drives, solid-state drives (SSDs), and/or tape drives and is used for non-volatile storage of data and as an over-flow storage device if the RAM is not large enough to hold all working data. The secondary storage may be used to store programs that are loaded into the RAM when such programs are selected for execution. The ROM is used to store instructions and perhaps data that are read during program execution. The ROM is a non-volatile memory device that typically has a small memory capacity relative to the larger memory capacity of the secondary storage. The RAM is used to store volatile data and perhaps to store instructions. Access to both the ROM and RAM is typically faster than to the secondary storage.

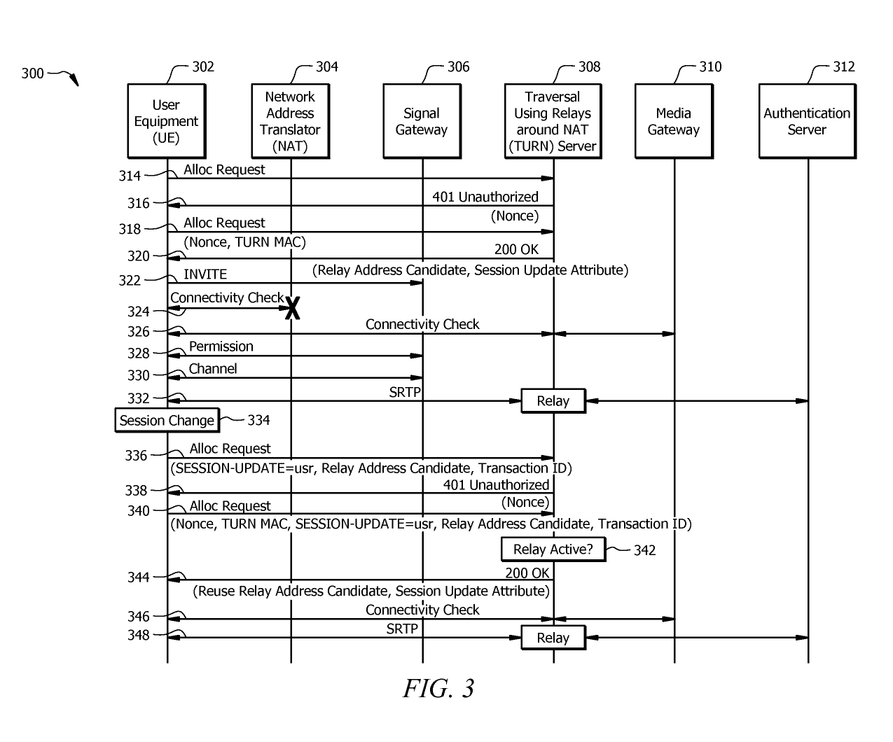

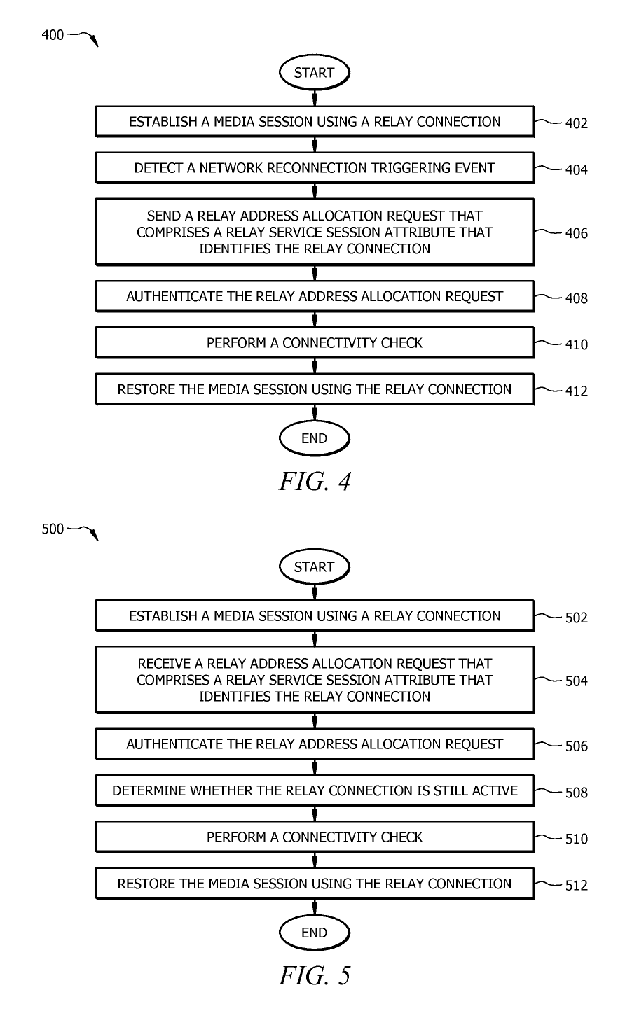

The memory module 250 may be used to house the instructions for carrying out the various example embodiments described herein. In one example embodiment, the memory module 250 comprises a relay service establishing module 260 that can be implemented on the processor 230. In one embodiment, the relay service establishing module 260 establishes a relay service for a media session and restores the relay service for the media session by reusing relay services following a network reconnection triggering event. For example, the relay service establishing module 260 is configured to establish a relay connection for a media session of a web session, to detect a network reconnection triggering event, and to restore the relay connection while reusing a relay connection address for the media session following the network reconnection triggering event. In an embodiment, such may be done according to relay service establishing method 300 described in FIG. 3, relay service establishing method 400 described in FIG. 4, and/or relay service establishing method 500 described in FIG. 5. Relay service establishing module 260 can be implemented in a transmitter (Tx), a receiver (Rx), or both.

It is understood that by programming and/or loading executable instructions onto the network element 200, at least one of the processors 230, the cache, and the long-term storage are changed, transforming the network element 200 in part into a particular machine or apparatus, for example, a multi-core forwarding architecture having the novel functionality taught by the present disclosure. It is fundamental to the electrical engineering and software engineering arts that functionality that can be implemented by loading executable software into a computer can be converted to a hardware implementation by well-known design rules known in the art. Decisions between implementing a concept in software versus hardware typically hinge on considerations of stability of the design and number of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable will be produced in large volume may be preferred to be implemented in hardware (e.g., in an ASIC) because for large production runs the hardware implementation may be less expensive than software implementations. Often a design may be developed and tested in a software form and then later transformed, by well-known design rules known in the art, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Any processing of the present disclosure may be implemented by causing a processor to execute instructions consistent with this disclosure. In this case, a computer program product can be provided to a computer or a network device using any type of non-transitory computer readable media. The computer program product may be stored in a non-transitory computer readable medium in the computer or the network device. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), compact disc read-only memory (CD-ROM), compact disc recordable (CD-R), compact disc rewritable (CD-R/W), digital versatile disc (DVD), Blu-ray (registered trademark) disc (BD), and semiconductor memories (such as mask ROM, programmable ROM (PROM), erasable PROM), flash ROM, and RAM). The computer program product may also be provided to a computer or a network device using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

FIG. 3 is a protocol diagram of an embodiment of relay service establishing protocol 300. Relay service establishing protocol 300 may be employed to establish a relay service for a media session and to restore the relay service for the media session by reusing relay services following a network reconnection triggering event. UE 302 may be configured similar to client 102 or target 108 described in FIG. 1. NAT 304 is configured to modify network address information in Internet Protocol (IP) datagram packet headers and to provide one-to-one IP address translations. For example, NAT 304 may be configured similar to as described in IETF RFC 2663 entitled, “IP Network Address Translator (NAT) Terminology and Considerations,” by Srisuresh, et al., published August 1999, which is hereby incorporated by reference as if reproduced in its entirety. Signal Gateway 306 is a network device that is configured to communicate signaling messages between UE 302 and the other network devices, such as, media gateway 310 and authentication server 312. TURN server 308 is a NAT traversal server and gateway for general purpose network traffic and media traffic. TURN server 308 may be configured to implement a TURN protocol similar to as described in IETF RFC 5766 entitled, “Traversal Using Relays around NAT (TURN): Relay Extensions to Session Traversal Utilities for NAT (STUN),” by Mahy, et al., published in April 2010, which is hereby incorporated by reference as if reproduced in its entirety. Media gateway 310 is a translation device or service that converts or distributes digital media streams between networks. Authentication server 312 is a network device that is configured to authenticate credentials for users, such as, account names and passwords. In an embodiment, UE 302, NAT 304, signal gateway 306, TURN server 308, media gateway 310, and authentication server 312 are configured to communicate with each other using a SIP protocol. For example, a SIP protocol may be similar to as described in IETF RFC 3261 entitled, “SIP: Session Initiation Protocol,” by Rosenberg, et al., published in June 2002, which is hereby incorporated by reference as if reproduced in its entirety. In another embodiment, UE 302, NAT 304, signal gateway 306, TURN server 308, media gateway 310, and/or authentication server 312 can be configured to communicate with each other using any other protocol as would be appreciated by one of ordinary skill in the art upon viewing this disclosure.

At step 314, UE 302 sends a relay address allocation request to TURN server 308. The relay address allocation request requests a relay address for communicating media traffic for a call (e.g., a WebRTC call). At step 316, UE 302 receives a user authentication request message (e.g., 401 unauthorized response code) that comprises a nonce from the TURN server 308 in response to the relay address allocation request. The nonce is a random or pseudorandom value issued by an authentication protocol that is used to verify a user. At step 318, UE 302 uses the nonce and TURN long-term credentials (e.g., TURN user name and password) to calculate a TURN message authentication code (MAC). For example, the nonce may be used with a hashing algorithm to determine the TURN MAC. Upon obtaining the TURN MAC, UE 302 sends another relay address allocation request that comprises the nonce and the TURN MAC to TURN server 308 to obtain relay addresses. For example, relay address may be Interactive Connectivity Establishment (ICE) relay candidates for UE 302. ICE candidates may include, but are not limited to, host candidates, server reflexive candidates, peer reflexive candidates, and relay candidates. Additional details for ICE candidates may be as described in IETF RFC 5245 entitled, “Interactive Connectivity Establishment (ICE): A Protocol for Network Address Translator (NAT) Traversal for Offer/Answer Protocols,” by J. Rosenberg, et. al., published April 2010, which is hereby incorporated by reference as if reproduced in its entirety. At step 320, TURN server 308 sends a relay address allocation request success message (e.g., 200 OK response code) to UE 302 that comprises a relay address candidate for the relay service and a session update attribute. In an embodiment, the session update attribute comprises a flag bit and provides a success code (e.g., a flag bit value) when the session has updated or a failure code (e.g., another flag bit value) when the session update fails. If the TURN server 308 does not support session updates, then the TURN server 308 sends a 200 OK response code without a session update attribute. At step 322, UE 302 sets up a call by sending an invitation request (e.g., an INVITE message) to signal gateway 306. In an embodiment, the invitation request comprises STUN credentials (e.g., a STUN username and password), a host address candidate, and the relay address candidate. For example, STUN credentials may be similar to as described in IETF RFC 3489 entitled, “STUN—Simple Traversal of User Datagram Protocol (UDP) Through Network Address Translators (NATs),” by Rosenberg, et al., published in March 2003, which is hereby incorporated by reference as if reproduced in its entirety.

At step 324, UE 302 performs a connectivity check with a peer (e.g., media gateway 310) to determine whether media can be sent directly to the peer. For instance, UE 302 determines that NAT 304 is a symmetric device or is employing a firewall that blocks UDP when the connectivity check with the peer fails. Relay services may be used when a connectivity check fails. At step 326, UE 302 performs a connectivity check with the peer (e.g., media gateway 310) using the relay address candidate and TURN server 308. A media session is established when the peer receives a connectivity check message and authenticates the connectivity check message. At step 328, UE 302 and signal gateway 306 exchange permission information. Permission information may be similar to as described in IETF RFC 5766. At step 330, UE 302 and signal gateway 306 exchange channel information. Channel information may be similar to as described in IETF RFC 5766. At step 332, UE 302 exchanges media traffic with the peer (e.g., media gateway 310), for example, using Secure Real-time Transport Protocol (SRTP). SRTP may be implemented substantially similar to as described in IETF RFC 3711 entitled, “The Secure Real-time Transport Protocol (SRTP),” by Baugher, et al., published in March 2004, which is hereby incorporated by reference as if reproduced in its entirety. In another embodiment, media traffic can be communicated between UE 302 and media gateway 310 using any other protocol as would be appreciated by one of ordinary skill in the art upon viewing this disclosure.

At step 334, UE 302 detects that a web session or a call connection is broken on a client due to a network reconnection triggering event during a WebRTC call. For example, a webpage presenting a WebRTC call on UE 302 is refreshed. At step 336, UE 302 sends a relay address allocation request to TURN server 308 that comprises a session update attribute (e.g., SESSION-UPDATE attribute) that indicates to restore the previous relay service connection by reusing relay services and allocating resources associated with the relay service. The session update attribute comprises a relay address candidate and may optionally comprise the transaction identifier (ID) of the most recent successful REFRESH request or ALLOCATE request and/or a TURN long-term user name for the relay connection associated with the previous relay connection. A transaction ID, a REFRESH request, and an ALLOCATE request may be similar to as described in IETF RFC 5766. The combination of the relay address candidate, the most recent REFRESH or ALLOCATE transaction ID, and the TURN long-term user name uniquely identifies a relay connection on TURN server 308 to use for restoring the previous relay connection. The relay address candidate may include, but is not limited to, an address (e.g., an IP address), a protocol identifier, and a port identifier. For media sessions that do not use relay services (e.g., when a symmetric NAT is not on a media path) but uses STUN to perform connectivity checks for direct media communications with a peer, the session update attribute comprises the STUN short-term user name and the peer's media address (e.g., media pinhole on media gateway 310) that uniquely identifies a previous media connection. When a session update attribute is present in a STUN binding request, the binding request is authenticated and the media connection (e.g., the peer address for a media pinhole on media gateway 310) is rebinded when authentication is successful. For example, the media connection may rebind using a protocol similar to as described in IETF draft draft-wing-mmusic-ice-mobility-07 entitled, “Mobility with ICE (MICE),” by Wing, et al., published in June 2014, which is hereby incorporated by reference as if reproduced in its entirety. At step 338, UE 302 receives a user authentication request message (e.g., 401 unauthorized response code) that comprises a nonce from the TURN server 308 in response to sending the relay address allocation request. At step 340, UE 302 uses the nonce and TURN long-term credentials to calculate the TURN MAC. For example, UE 302 uses a nonce that may be used with a hashing algorithm to determine the TURN MAC similarly to as described in step 318. Upon obtaining the TURN MAC, UE 302 sends another relay address allocation request that comprises the nonce, the TURN user name, the TURN MAC, and the session update attribute to TURN server 308. Optionally, the TURN user name in the session update attribute may be omitted when the TURN user name is identical to the TURN USERNAME attribute in the relay request allocation request.

At step 342, TURN server 308 authenticates the relay address allocation request and determines whether the relay session for the previous relay connection is still active. TURN server 308 may allocate a new relay address candidate when the relay address of the previous relay connection is no longer active; otherwise, TURN server 308 proceeds to step 344. At step 344, TURN server 308 will send a relay address allocation request success message (e.g., 200 OK response code) that comprises the session update attribute to UE 302 when the relay address for the previous relay connection is still active. The session update attribute comprises a success code when the session update is successful or a failure code when the session update fails. For example, a session update may fail when the relay address expires on TURN server 308. The relay address allocation request success message with a session update attribute success code indicates to reuse the previous relay address. When TURN server 308 does not support session updates, the session update attribute may be omitted in the 200 OK response code. At step 346, UE 302 performs a connectivity check with a peer (e.g., media gateway 310) using the relay connection and the TURN server. The media session is restored when media gateway 310 receives the connectivity check message and authenticates the connectivity check message. At step 348, UE 302 exchanges media traffic with media gateway 310, for example, using SRTP. In another embodiment, media traffic can be communicated between UE 302 and media gateway 310 using any other protocol as would be appreciated by one of ordinary skill in the art upon viewing this disclosure.

FIG. 4 is a flowchart of an embodiment of a relay service establishing method 400 for a network device to establish a relay service and to restore the relay service by reusing relay services after a network reconnection triggering event, which may be similar to instructions stored in relay service establishing module 260 described in FIG. 2. Relay service establishing method 400 is implemented to establish a relay connection for a media session or to restore the relay connection for a media session by reusing relay connection addresses following a network reconnection triggering event. In an embodiment, a network device (e.g., UE 302 described in FIG. 3) is configured to establish a media session using a relay service (e.g., a relay connection) for a media session, to detect a network reconnection triggering event, and to restore the media session using the previous relay connection.

At step 402, the network device establishes a media session for a web session (e.g., a WebRTC call) using a relay connection. The network device sends a relay address allocation request to a TURN server (e.g., TURN server 308 described in FIG. 3) to request a relay address candidate for a media session. In response to sending the relay address allocation request, the network device receives a user authentication request message from the TURN server. The network device sends another relay address allocation request to the TURN server that comprises a TURN MAC to authenticate the relay address allocation request. The network device then receives a relay address allocation request success message that comprises a relay address candidate. The network device performs a connectivity check with a peer (e.g., media gateway) using the relay address candidate and the TURN server to establish the media session. Establishing a media session using a relay connection may be similar to steps 314-332 described in FIG. 3.

At step 404, the network device detects that a call connection is broken on a client due to a network reconnection triggering event. For example, the network device may detect a user refreshing a page, a user leaving a page (e.g., clicks back or forward button), a device moving out of and back into a hot spot, or a device turning off and back on. Detecting a network reconnection triggering event may be similar to step 334 described in FIG. 3. At step 406, the network device sends a relay address allocation request that comprises a session update attribute that identifies the previous relay connection. Sending a relay address allocation request that comprises a session update attribute may be similar to step 336 described in FIG. 3. At step 408, the network device authenticates the relay address allocation request with the TURN server by exchanging authorization credentials (e.g., TURN MAC) and the session update attribute. When the relay address allocation request is authenticated and the previous relay connection is still active, the network device receives a relay address allocation request success message. Authenticating the relay address allocation request may be similar to steps 338-344 described in FIG. 3. At step 410, the network device performs a connectivity check with a media gateway (e.g., media gateway 310 described in FIG. 3) using the relay connection and the TURN server to restore the media session similar to step 346 described in FIG. 3. At step 412, the network device communicates data traffic or media traffic upon restoring the media session using the relay connection similar to step 348 described in FIG. 3.

FIG. 5 is a flowchart of another embodiment of a relay service establishing method 500 for a network device to establish a relay service and to restore the relay service by reusing relay services after a network reconnection triggering event, which may be similar to instructions stored in relay service establishing module 260 described in FIG. 2. Relay service establishing method 500 is implemented to establish a relay connection for a media session or to restore the relay connection for a media session by reusing relay connection addresses following a network reconnection triggering event. In an embodiment, a network device (e.g., TURN server 308 described in FIG. 3) is configured to establish a media session using a relay service (e.g., a relay connection) for a media session and to restore the media session using the previous relay connection.

At step 502, the network device establishes a media session for a web session (e.g., a WebRTC call) using a relay connection. The network device receives a relay address allocation request from a client on a UE (e.g., UE 302 described in FIG. 3) to request a relay address candidate for a media session. In response to receiving the relay address allocation request, the network device sends a user authentication request message to the UE. The network device receives another relay address allocation request from the UE that comprises a TURN MAC to authenticate the previous relay address allocation request. Upon authenticating the relay address allocation request, the network device sends a relay address allocation request success message that comprises a relay address candidate. The network device relays a connectivity check between the UE and a peer (e.g., media gateway 310 described in FIG. 3) using the relay address candidate to establish the media session. Establishing a media session using a relay connection may be similar to steps 314-332 described in FIG. 3.

At step 504, the network device receives a relay allocation request that comprises a session update attribute that identifies the previous relay connection. Receiving a relay address allocation request that comprises a session update attribute may be similar to step 336 described in FIG. 3. At step 506, the network device authenticates the relay address allocation request. The network device authenticates the relay address allocation request by receiving authorization credentials (e.g., TURN MAC) and the session update attribute from the UE. Authenticating the relay address allocation request may be similar to steps 338 and 340 described in FIG. 3. At step 508, the network device determines whether the relay connection is still active. When the relay connection is still active the network device sends a relay address allocation request success message and proceeds to step 510; otherwise, the network device allocates a new relay address candidate. Determining whether a relay connection is still active may be similar to steps 342 and 344 described in FIG. 3. At step 510, the network device performs a connectivity check with a UE and a media gateway (e.g., media gateway 310 described in FIG. 3) using the relay connection to restore the media session similar to step 346 described in FIG. 3. At step 512, the network device communicates data traffic and/or media traffic upon restoring the media session using the relay connection similar to step 348 described in FIG. 3.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed:

1. A call media session restoration method comprising:
detecting a network reconnection triggering event that disconnects a media session for a client and a relay connection on a network device for the media session;
sending a relay address allocation request to the network device, wherein the relay address allocation request comprises a session update attribute that identifies a relay address for the relay connection;
receiving a user authentication request message from the network device in response to sending the relay address allocation request;
authenticating the relay address allocation request with the network device, wherein the relay address allocation request is authenticated in accordance with the user authentication request message, and wherein authenticating the relay address allocation request comprises resending the session update attribute; and
performing a connectivity check between the client and a peer via the relay connection, wherein performing the connectivity check restores the media session and the relay connection, and wherein restoring the relay connection reuses the relay address for the relay connection.

2. The method of claim 1, wherein restoring the relay connection reuses at least one of relay permissions, relay channel binding, or relay bandwidth.

3. The method of claim 1, wherein authenticating the relay address allocation request comprises:
obtaining a Traversal Using Relays around Network Address Translator (TURN) message authentication code (MAC) using TURN long-term credentials associated with the client; and
providing the TURN MAC and the session update attribute to the network device to authenticate the client.

4. The method of claim 1, wherein the network device is a Traversal Using Relays around Network Address Translator (TURN) server.

5. The method of claim 1, further comprising communicating media traffic for the media session using the relay connection.

6. The method of claim 1, wherein the media session is for a Web Real-Time Communications (WebRTC) call.

7. An apparatus, comprising:
a receiver configured to receive signaling commands and data traffic; and
a processor coupled to a memory and the receiver, wherein the memory comprises computer executable instructions stored in a non-transitory computer readable medium such that when executed by the processor causes the processor to:
detect a network reconnection triggering event that disconnects a media session for a client and a relay connection on a network device for the media session;
send a relay address allocation request to the network device, wherein the relay address allocation request comprises a session update attribute that identifies a relay address for the relay connection;
receive a user authentication request message from the network device in response to sending the relay address allocation request;
authenticate the relay address allocation request with the network device, wherein the relay address allocation request is authenticated in accordance with the user authentication request message, and wherein authenticating the relay address allocation request comprises resending the session update attribute; and
perform a connectivity check between the client and a media gateway via the relay connection, wherein performing the connectivity check restores the media session and the relay connection, and wherein restoring the relay connection reuses the relay address for the relay connection.

8. The apparatus of claim 7, wherein authenticating the relay address allocation request comprises receiving a relay address allocation request success message that comprises the session update attribute, wherein the session update attribute comprises a success code.

9. The apparatus of claim 7, wherein authenticating the relay address allocation request comprises:
obtaining a Traversal Using Relays around Network Address Translator (TURN) message authentication code (MAC) using TURN long-term credentials associated with the client; and
providing the TURN MAC and the session update attribute to the network device to authenticate the client.

10. The apparatus of claim 7, wherein the network device is a Traversal Using Relays around Network Address Translator (TURN) server.

11. The apparatus of claim 7, wherein the session update attribute comprises a transaction identifier (ID) and a Traversal Using Relays around Network Address Translator (TURN) user name.

12. The apparatus of claim 7, wherein restoring the relay connection reuses at least one of relay permissions, relay channel binding, or relay bandwidth.

13. The apparatus of claim 7, wherein the session update attribute comprises a Traversal Using Relays around Network Address Translator (TURN) user name when the relay address allocation request does not comprise a TURN long-term user name.

14. An apparatus, comprising:
a receiver configured to receive signaling commands and data traffic; and
a processor coupled to a memory and the receiver, wherein the memory comprises computer executable instructions stored in a non-transitory computer readable medium such that when executed by the processor causes the processor to:
receive a relay address allocation request from a client following a network reconnection triggering event, wherein the relay address allocation request comprises a session update attribute that identifies a relay connection address for a relay connection for a media session, and wherein the network reconnection triggering event disconnects the media session and the relay connection on a network device for the media session;
send a user authentication request message to the client to authenticate the relay address allocation request with the client;
determine whether the relay connection address is still active;
send a relay address allocation request success message to the client; and
relay a connectivity check between the client and a peer using the relay connection when the relay address allocation request is authenticated and the relay connection address is still active, wherein relaying the connectivity check restores the media session and the relay connection, and wherein restoring the relay connection reuses the relay connection address.

15. The apparatus of claim 14, wherein sending the relay address allocation request success message comprises sending the session update attribute and a success code in the relay address allocation success message when session updates are supported, and wherein sending the relay address allocation request success message comprises omitting the session update attribute from the relay address allocation success message when session updates are not supported.

16. The apparatus of claim 14, wherein the computer executable instructions further cause the processor to allocate a new relay connection when the relay connection is no longer active.

17. The apparatus of claim 14, wherein authenticating the relay address allocation request comprises receiving a Traversal Using Relays around Network Address Translator (TURN) message authentication code (MAC) and the session update attribute from the client in response to the user authentication request message.

18. The apparatus of claim 14, wherein the computer executable instructions further cause the processor to communicate media traffic for the media session via the relay connection.

19. The apparatus of claim 14, wherein the session update attribute comprises a Traversal Using Relays around Network Address Translator (TURN) user name when the relay address allocation request does not comprise a TURN long-term user name.

20. The apparatus of claim 14, wherein the media session is for a Web Real-Time Communications (WebRTC) call.
